(19) United States
(12) Patent Application Publication
(10) Pub. No.: US 2019/0001323 A1
(43) Pub. Date: Jan. 3, 2019

(54) FILTRATION DEVICE WITH MULTIPLE POST-FILTRATION ORIENTATIONS

(71) Applicant: BOSTON SCIENTIFIC SCIMED, INC., MAPLE GROVE, MN (US)

(72) Inventors: SARAH JEAN HEIGHTON, CLINTON, MA (US); SHANNON SMITH KENWOOD, HOPKINTON, MA (US); JOSHUA CLARK, SPENCER, IN (US)

(73) Assignee: BOSTON SCIENTIFIC SCIMED, INC., MAPLE GROVE, MN (US)

(21) Appl. No.: 16/022,108

(22) Filed: Jun. 28, 2018

Related U.S. Application Data
(60) Provisional application No. 62/527,638, filed on Jun. 30, 2017.

(51) Int. Cl. B01L 3/00; B01D 63/08; B01D 61/18

(52) U.S. Cl. CPC B01L 3/5021; B01D 63/087; B01D 61/18; B01D 2311/2676; B01L 2300/0832; B01D 2313/025; B01L 2300/0681; B01L 2400/0409; B01L 2400/08; B01D 2315/02

(57) ABSTRACT

A cell filtration assembly adapted to capture cells from a biological sample during centrifugation includes a centrifugation tube, a cell collection device adapted to be secured within a tapered end of the centrifugation tube and a funnel structure adapted to direct fluid into the cell collection device. The cell collection device includes a rectilinear structure that is adapted to permit fluid to flow through the rectilinear structure and a cell capture surface that is secured relative to the rectilinear structure. The cell collection device may be sectioned in either a horizontal or vertical orientation.

### CROSS-REFERENCE TO RELATED APPLICATIONS

This application claims priority under 35 U.S.C. § 119 to U.S. Provisional Application Ser. No. 62/527,638, filed Jun. 30, 3017, the entirety of which is incorporated herein by reference.

### TECHNICAL FIELD

The present disclosure pertains to medical devices, and methods for manufacturing medical devices. More particularly, the present disclosure pertains to filtration devices usable in processing biological samples.

### BACKGROUND

A wide variety of medical devices have been developed for medical use, for example for collecting and/or processing biological samples. Some of these devices include filtration devices. Of the known medical devices and methods, each has certain advantages and disadvantages. There is an ongoing need to provide alternative medical devices as well as alternative methods for using medical devices.

### BRIEF SUMMARY

This disclosure provides design, material, manufacturing method, and use alternatives for medical devices. An example medical device includes a cell filtration assembly that is adapted to capture cells from a biological sample during centrifugation. The cell filtration assembly includes a centrifugation tube having a tapered end and being adapted to be placed in a centrifuge as well as a cell collection device that is adapted to be secured within the centrifugation tube proximate the tapered end thereof. The cell collection device includes a rectilinear structure that is adapted to permit fluid to flow through the rectilinear structure, a cell capture surface that is secured relative to the rectilinear structure and a funnel structure that is disposed within the centrifugation tube and is adapted to direct fluid into the cell collection device.

Alternatively or additionally to any of the embodiments above, the cell collection device further includes at least one filter membrane secured relative to the rectilinear structure that permits fluid to flow through the rectilinear structure.

Alternatively or additionally to any of the embodiments above, the cell capture surface includes a filter membrane.

Alternatively or additionally to any of the embodiments above, the cell capture surface includes a fluid-impervious surface.

Alternatively or additionally to any of the embodiments above, the cell collection device includes a material that can be embedded and sectioned.

Alternatively or additionally to any of the embodiments above, the cell collection device may be adapted to be placed in a mold for embedding and sectioning in a horizontal orientation.

Alternatively or additionally to any of the embodiments above, the cell collection device may be adapted to be placed in a mold for embedding and sectioning in a vertical orientation.

Alternatively or additionally to any of the embodiments above, the funnel structure may be adapted to be secured within the centrifugation tube via a frictional fit.

Alternatively or additionally to any of the embodiments above, the funnel structure may be adapted to secure the cell collection device in position within the tapered end of the centrifugation tube.

A cell filtration assembly is disclosed. The cell filtration assembly comprises: a centrifugation tube comprising a tapered end; a cell collection device adapted to be secured within the centrifugation tube proximate the tapered end thereof, the cell collection device comprising a rectilinear structure configured to permit fluid to flow through the rectilinear structure; and a funnel structure to direct fluid into the cell collection device.

Alternatively or additionally to any of the embodiments above, the cell collection device further includes at least one filter membrane secured relative to the rectilinear structure that permits fluid to flow through the rectilinear structure.

Alternatively or additionally to any of the embodiments above, further comprising a cell capture surface secured relative to the rectilinear structure, the cell capture surface comprising a filter membrane.

Alternatively or additionally to any of the embodiments above, further comprising a cell capture surface secured relative to the rectilinear structure, the cell capture surface comprising a fluid-impervious surface

Alternatively or additionally to any of the embodiments above, the cell collection device includes a material that can be embedded and sectioned.

Alternatively or additionally to any of the embodiments above, the cell collection device may be adapted to be placed in a mold for embedding and sectioning in a horizontal orientation.

Alternatively or additionally to any of the embodiments above, the cell collection device may be adapted to be placed in a mold for embedding and sectioning in a vertical orientation.

Alternatively or additionally to any of the embodiments above, the funnel structure may be adapted to be secured within the centrifugation tube via a frictional fit.

Alternatively or additionally to any of the embodiments above, the funnel structure may be adapted to secure the cell collection device in position within the tapered end of the centrifugation tube.

Another example medical device includes a cell collection device that is adapted to be used in combination with a centrifugation tube in collecting cells or other tissue from a biological sample. The cell collection device includes a rectilinear structure that is adapted to permit fluid to flow through the rectilinear structure, a filter membrane that is secured relative to a side panel of the rectilinear structure and a cell capture surface that is secured relative to a bottom panel of the rectilinear structure. The rectilinear structure may be dimensioned to enable the cell collection device to be placed in a mold and subsequently embedded in either a vertical orientation or a horizontal orientation.

A cell collection device is disclosed. The cell collection device comprises: a rectilinear structure configured to permit fluid to flow through the rectilinear structure; a filter membrane secured relative to a side panel of the rectilinear structure; and a cell capture surface secured relative to a bottom panel of the rectilinear structure; wherein the rectilinear structure is dimensioned to enable the cell collection device to be placed in a mold and subsequently embedded in either a vertical orientation or a horizontal orientation.

Alternatively or additionally to any of the embodiments above, the rectilinear structure has a first dimension of about 5 millimeters or less.

Alternatively or additionally to any of the embodiments above, the first dimension is about 5 millimeters.

Alternatively or additionally to any of the embodiments above, the rectilinear structure has a second dimension, orthogonal to the first dimension, that is about 5 millimeters or less.

Alternatively or additionally to any of the embodiments above, the second dimension is about 3 millimeters.

Alternatively or additionally to any of the embodiments above, the cell capture surface includes a filter membrane.

Alternatively or additionally to any of the embodiments above, the cell capture surface includes a filter membrane having a pore size of about 5 micrometers.

Alternatively or additionally to any of the embodiments above, the cell capture surface includes a fluid-impervious surface.

Alternatively or additionally to any of the embodiments above, the cell collection device is formed of a polymer.

An example method of processing cells from a biological sample includes capturing cells from the biological sample in a cell collection device having a cell capture surface arranged within a rectilinear structure, placing the cell collection device into an embedding mold in a first orientation if the biological sample contained a large number of cells or placing the cell collection device into the embedding mold in a second orientation orthogonal to the first orientation if the biological sample did not contain a large number of cells and embedding the cell collection device in wax.

Alternatively or additionally to any of the embodiments above, the method further includes subsequently sectioning the biological sample.

The above summary of some embodiments is not intended to describe each disclosed embodiment or every implementation of the present disclosure. The Figures, and Detailed Description, which follow, more particularly exemplify these embodiments.

### BRIEF DESCRIPTION OF THE DRAWINGS

The disclosure may be more completely understood in consideration of the following detailed description in connection with the accompanying drawings, in which:

FIG. 1 is a side view of an illustrative cell filtration assembly in accordance with the disclosure;

FIG. 2 is a perspective view of an illustrative cell collection device forming a portion of the cell filtration assembly of FIG. 1;

FIGS. 3A and 3B are side and perspective, respectively, views of a tissue processing cassette in accordance with the disclosure;

FIG. 4 illustrates several embedding molds in accordance with the disclosure;

FIG. 5 is a schematic illustration of the cell collection device of FIG. 2, embedded in a first orientation corresponding to a cell-rich sample, that provides more cells per slide in accordance with the disclosure;

FIG. 6 is a schematic illustration of the cell collection device of FIG. 2, embedded in a second orientation corresponding to a cell-poor sample, that provides more slides per block;

FIG. 7 is a schematic illustration of sectioning results comparing the orientation of FIG. 5 with the orientation of FIG. 6; and

FIG. 8 is a flow diagram showing an illustrative method of processing cells.

While the disclosure is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the disclosure.

### DESCRIPTION

For the following defined terms, these definitions shall be applied, unless a different definition is given in the claims or elsewhere in this specification.

All numeric values are herein assumed to be modified by the term “about”, whether or not explicitly indicated. The term “about” generally refers to a range of numbers that one of skill in the art would consider equivalent to the recited value (e.g., having the same function or result). In many instances, the terms “about” may include numbers that are rounded to the nearest significant figure.

The recitation of numerical ranges by endpoints includes all numbers within that range (e.g. 1 to 5 includes 1, 1.5, 2, 2.75, 3, 3.80, 4, and 5).

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include one or more particular features, structures, and/or characteristics. However, such recitations do not necessarily mean that all embodiments include the particular features, structures, and/or characteristics. Additionally, when particular features, structures, and/or characteristics are described in connection with one embodiment, it should be understood that such features, structures, and/or characteristics may also be used connection with other embodiments whether or not explicitly described unless clearly stated to the contrary.

The following detailed description should be read with reference to the drawings in which similar elements in different drawings are numbered the same. The drawings, which are not necessarily to scale, depict illustrative embodiments and are not intended to limit the scope of the invention.

There are a number of methods for the collection of biological samples by a biopsy and/or other surgical processes. Such processes typically result in a tissue sample that can be routinely processed for pathological analysis. In some endoscopic procedures such as those where a fine needle aspiration device is utilized, the sample that is collected includes loose cells and fluids. Prior to tissue processing and/or analysis, additional steps may be necessary to gather the desired cells/tissue and allow the cells/tissue to be further processed. Disclosed herein are devices and methods that allow cells/tissue to be efficiently processed and/or analyzed including cells/tissue gathered by fine needle aspiration devices and/or other devices that collect cells/tissue along with fluids. In some cases, for example, the devices and methods described herein may be used in processing cells, tissue or other biological samples obtained using other techniques as well.

In some cases, a biological sample including cells or other tissue within a fluid may be subjected to centrifugation in order to collect the cells or other tissue on a substrate for subsequent processing and examination while eliminating the fluid that previously carried the cells or other tissue. Once the cells are captured on a substrate such as but not limited to a filter membrane, they may be treated with other reagents, fixing agents, and the like, during tissue processing. The cells may subsequently be embedded in a medium, such as but not limited to a wax such as paraffin wax. In some cases, the cells embedded in a medium may be referred to as a cell block. The cell block may subsequently be sectioned into thin slices for mounting on a glass slide for analysis on a microscope, for example, or sliced from the cell block for other analytical processes. For example, visualization of the cells and the extracellular environment can provide information to determine whether the tissue collected is benign or malignant. Alternatively, the slices provide cellular material (DNA, RNA, proteins) for microcellular analysis.

In some cases, a biological sample may be initially processed by placing the biological sample, which typically includes cells or other tissue of interest, within a fluid, into a centrifuge tube and spinning or otherwise centrifuging the biological sample in order to capture the cells or other tissue of interest on a substrate such as a filter membrane while driving off the extraneous fluid. In some cases, the centrifuge tube may include a fixative, which refers to a compound that helps to preserve the cells or other tissue of interest. Illustrative but non-limiting examples of suitable fixatives include formalin, ethanol and methanol. In some cases, saline may be included as a holding solution. Another example is RPMI medium, or Rosewell Park Memorial Institute medium, which is a medium used in cell culture and tissue culture. In some cases, a centrifuge tube may have a volume ranging from about 15 milliliters (ml) to about 50 ml, although this is merely illustrative. In some instances, the centrifuge tube may accommodate a filter membrane upon which the cells or other tissue of interest may be collected, as will be discussed subsequently. The centrifuge tube may be spun in a standard centrifuge at speeds that subject the contents of the centrifuge tube to relative centrifugal forces (RCF) of between about 300 to about 1800 RCF.

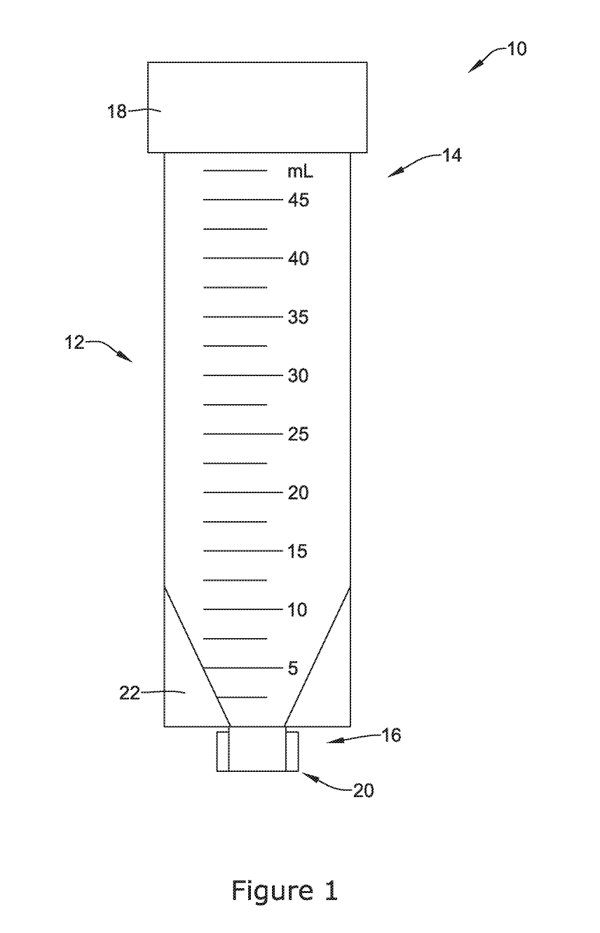

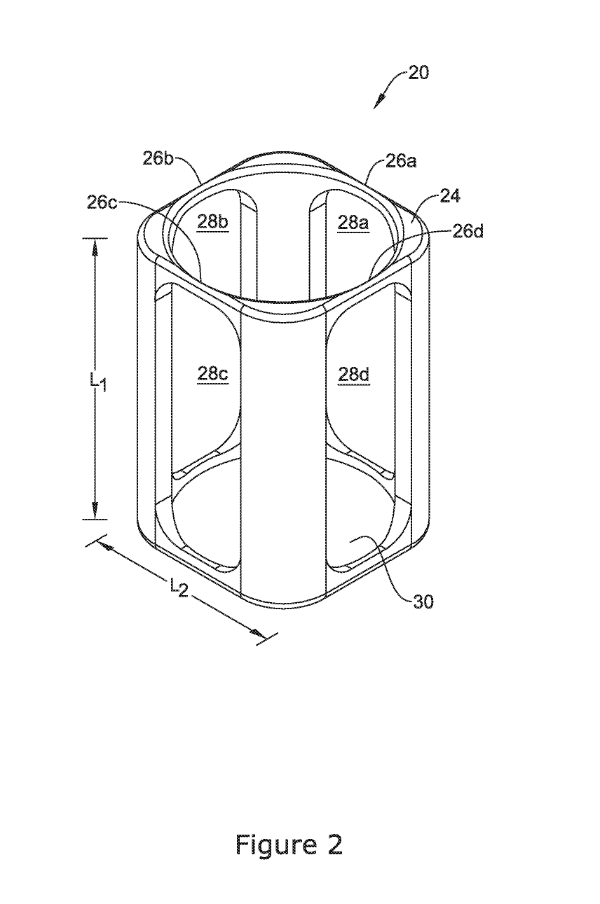

FIG. 1 is a side view of a cell filtration assembly 10 that may be considered as being adapted to capture cells or other tissue of interest from a biological sample during centrifugation. The biological sample may include cells or other tissue of interest suspended within a fluid, which may for example include one or more fixatives as listed above. The cell filtration assembly 10 includes a centrifugation tube 12 that is adapted to be placed into a centrifuge. The centrifugation tube 12 extends from a first end 14 to a tapered end 16. In some cases, as illustrated, the centrifugation tube 12 may include a cap 18 that is threadedly engaged with the first end 14 of the centrifugation tube 12. A cell collection device 20 is disposed within the tapered end 16 such that as the cell filtration assembly 10 undergoes centrifugation, the biological sample is forced downward (in the illustrated orientation) towards the tapered end 16, and thus into the cell collection device 20. As the biological sample moves toward and into the cell collection device 20, the cells and other tissue of interest may be captured on a cell collection surface (discussed with respect to FIG. 2) while any fluids present may pass through the cell collection device 20.

In some cases, as illustrated, the cell filtration assembly 10 includes a funnel structure 22 that is disposed within the centrifugation tube 12. In some cases, the funnel structure 22 may have a conical interior shape, and may help to direct fluid downward into the cell collection device 20, rather than allowing fluid to flow around an exterior of the cell collection device 20. In some cases, the funnel structure 22 also helps to position the cell collection device 20 relative to the tapered end 16 of the centrifugation tube 12, and may help to hold the cell collection device 20 in place. In some cases, for example, the funnel structure 22 may be held in place within the centrifugation tube 12 via a compressive or frictional fit. In some instances, the funnel structure 22 may be adhesively secured in place within the centrifugation tube 12. In some cases, the funnel structure 22 is not secured in place, but is held in position relative to the centrifugation tube 12 and the cell collection device 20 via forces resulting from centrifugation. As a result, after centrifugation, a technician may remove the cell collection device 20 from the centrifugation tube 12 by simply removing the cap 18 and using forceps or a similar tool to remove the cell collection device from the centrifugation tube 12. After removing the cell collection device 20 from the centrifugation tube 12, it can be capped. The cap may be a separate piece, and may either be solid or include a filter membrane.

FIG. 2 illustrates the cell collection device 20. In some cases, the cell collection device 20 may be considered as including a rectilinear structure 24 that is adapted to permit fluid to flow through. The rectilinear structure 24 may be considered as including a total of four side panels 26a, 26b, 26c and 26d. In some cases, one or more of the side panels 26a, 26b, 26c and 26d may include filter membranes that are adapted to prevent cells and/or other tissue of interest from escaping, yet permit fluids to flow through. As illustrated, the side panel 26a includes a filter membrane 28a, the side panel 26b includes a filter membrane 28b, the side panel 26c includes a filter membrane 28c and the side panel 26d includes a filter membrane 28d. It will be appreciated that this is merely illustrative, as in some cases one or more of the side panels 26a, 26b, 26c and 26d may not include a corresponding filter membrane.

The cell collection device 20 includes a cell capture surface 30. In some cases, the cell capture surface 30 may be fluid-impervious, as long as the cell collection device 20 includes other filter membranes, such as but not limited to one or more of the filter membranes 28a, 28b, 28c and 28d. In some cases, the cell capture surface 30 may itself be a filter membrane, which means that the other filter membranes 28a, 28b, 28c and 28d may, in some cases, be optional. In cases where the cell capture surface 30 is a filter membrane, or is otherwise a porous surface, the cell capture surface 30 may be formed of a porous material with openings sized to allow the desired cells/tissue to be collected thereon while allowing fluids to pass therethrough. For example, the cell capture surface 30 (or any of the filter membranes 26a, 26b, 26c and 26d) may have pores that are about 0.1-50 micrometers, or about 1-20 micrometers, or about 2-10 micrometers, or about 5 micrometers, or smaller than about 10 micrometers, or smaller than about 5 micrometers, or the like.

In some cases, the cell collection device 20 may be formed of a material that can be embedded and sectioned. Examples of suitable materials include but are not limited to thermoplastic polymers, thermosetting polymers and paraffin wax. In some cases, the cell collection device 20 may be dimensioned such that the cell collection device 20 may be placed in a mold for embedding and sectioning in a horizontal orientation. In some cases, the cell collection device 20 may be able to be placed in a mold for embedding and sectioning in a vertical orientation. As will be discussed, being able to select either a horizontal orientation or a vertical orientation provides benefits in dealing with cell-rich biological samples and cell-poor biological samples. In some instances, the rectilinear structure 24 has a first dimension L1 and a second dimension L2 that is orthogonal to the first dimension L1. In some cases, L1 may have a dimension of about 5 millimeters or less. In some cases, L2 may have a dimension of about 5 millimeters or less. In a particular example, L1 and L2 may each be about 5 millimeters. In another particular example, L1 may be about 5 millimeters and L2 may be about 3 millimeters.

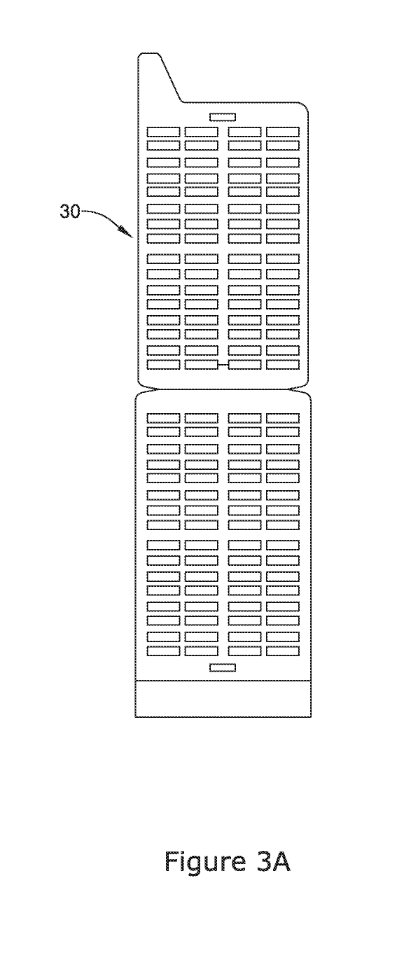

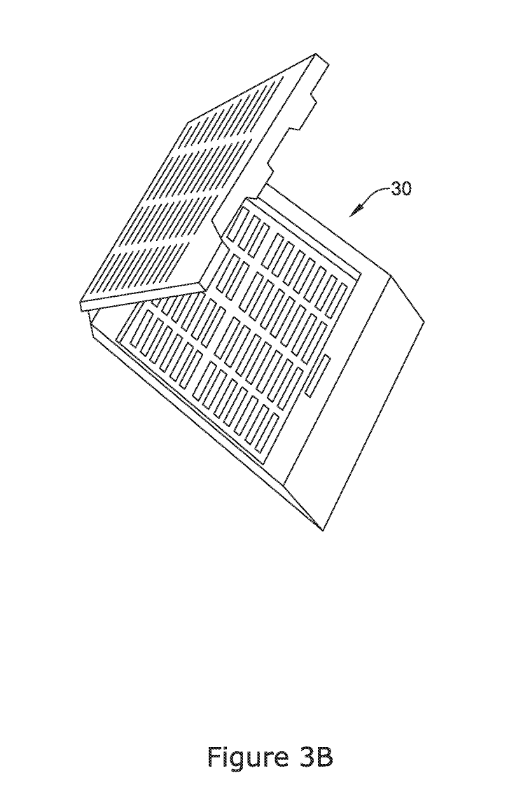

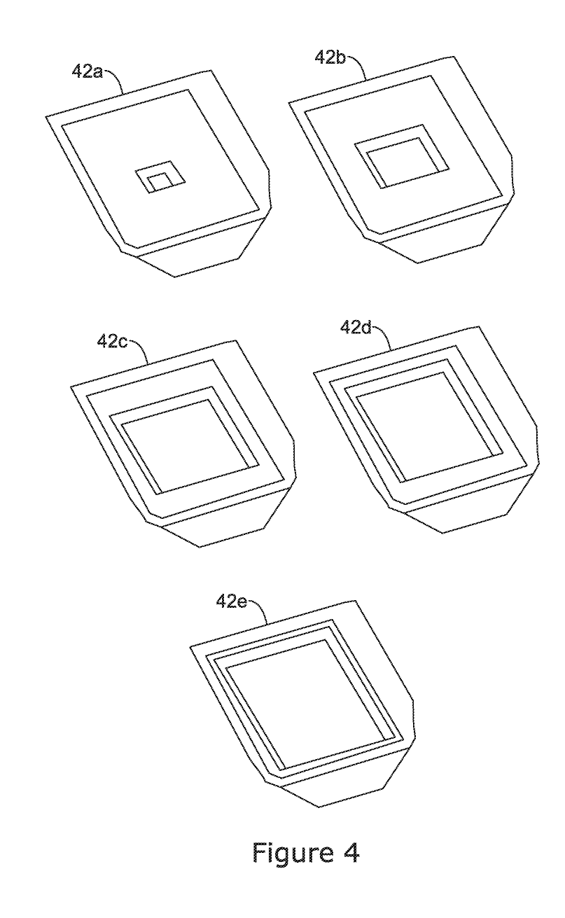

In some cases, the relative dimensions for L1 and L2 may be selected in order to permit the cell collection device 20 to be placed into tissue processing cassettes and/or embedding molds. FIGS. 3A and 3B provide side and perspective views, respectively, of a tissue processing cassette 30. In some cases, the tissue processing cassette 30 may define an interior space measuring about 26 millimeters by about 30 millimeters by about 5 millimeters. FIG. 4 provides views of several embedding molds 42a, 42b, 42c, 42d, 42e having various dimensions. However, in general, each of the embedding molds 42a, 42b, 42c, 42d, 42e have a depth of about 5 millimeters. It will be appreciated that the aforementioned dimensions for L1 and L2 enable the cell collection device 20 to be placed into the tissue processing cassette 30 and/or into any of the embedding molds 42a, 42b, 42c, 42d, 42e in either a vertical orientation or a horizontal orientation.

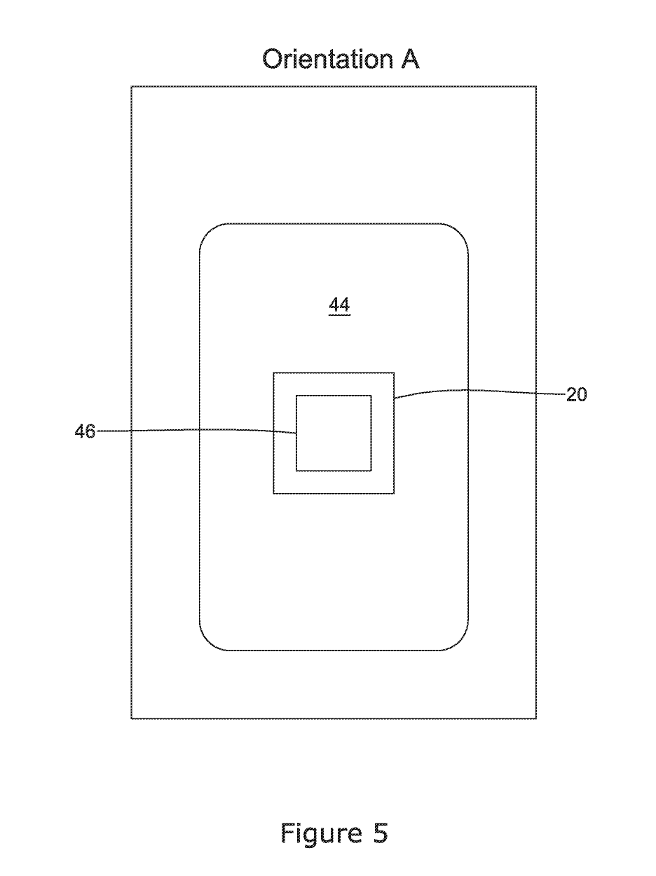

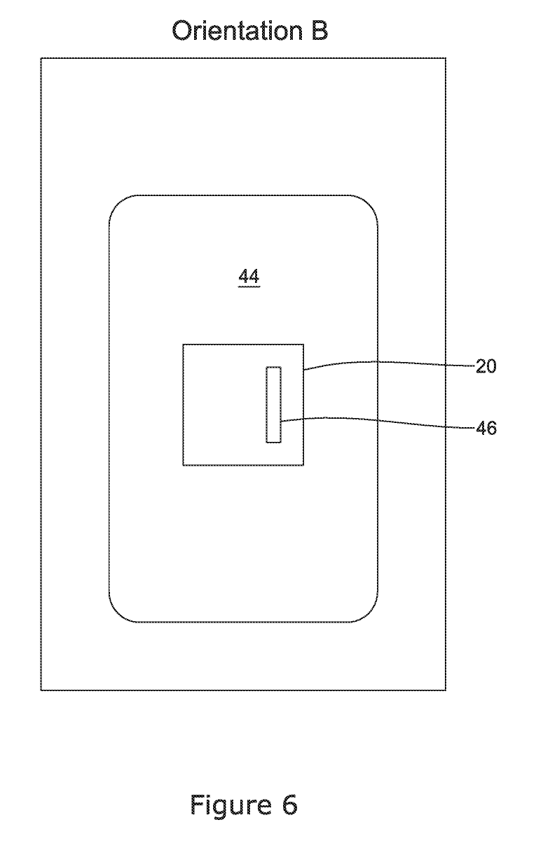

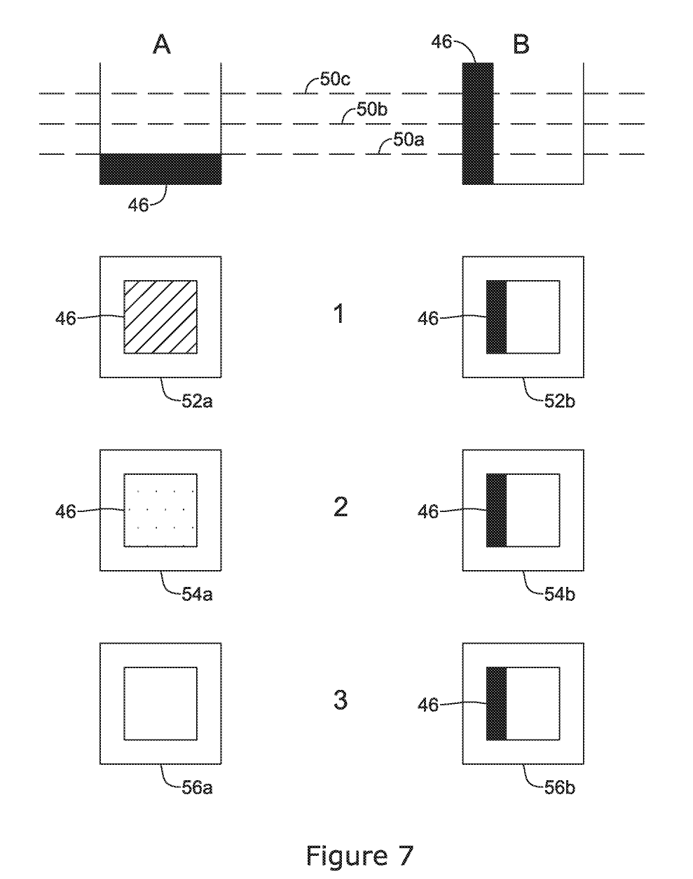

To illustrate, FIGS. 5 and 6 show the cell collection device 20 embedded in a paraffin block 44 as a result of a molding process. In FIG. 5, the cell collection device 20 may be seen as being embedded in an Orientation A while FIG. 6 illustrates an Orientation B. The relative orientation of cells 46 can be seen as being distinctly different between Orientation A and Orientation B. In some cases, for example, a highly cellular sample, or a sample that is cell-rich, may be embedded in Orientation A, which can provide more cells per slide. A scant sample, or a sample that is cell-poor, may be embedded in Orientation B, which can provide more sections that include cells. This is further illustrated in FIG. 7.

FIG. 7 schematically illustrates the relative results of sectioning with the cell collection device 20 in Orientation A and in Orientation B. While a total of three cutting planes 50a, 50b and 50c are shown, it will be appreciated that this is highly schematic, and in practice there would be a higher number of cutting planes given that the desired sections are generally 4 to 6 micrometers in thickness, and there can be a more gradual gradient in the relative amounts of cells in each sample, particularly for cuttings from the Orientation A.

Comparing the first samples 52a and 52b, which result from the cutting plane 50a, both can be seen to have a significant representation of cells 46. Moving to the second samples 54a and 54b, which result from the cutting plane 50b, it can be seen that the sample 54a has fewer cells 46 while the sample 54b has at least substantially the same amount of cells 46 as the sample 52b. Moving to the third samples 56a and 56b, which result from the cutting plate 50c, it can be seen that the sample 56a has essentially no cells, while the sample 56b has at least substantially the same amount of cells 46 as the sample 52b or the sample 54b.

It will be appreciated, therefore, that being able to select the relative orientation of the cell collection device 20 can be beneficial in dealing with cell-rich or cell-poor biological samples. Being able to select the relative orientation of the cell collection device 20 can also be beneficial in dealing with particular demands for how many slides can be obtained from a particular sample. For example, in some cases such as molecular testing, there can be a desire to have as many as 30 slides from a particular cell block. In other cases, there may be a desire to provide a slide or slides that include a large number of cells, for example.

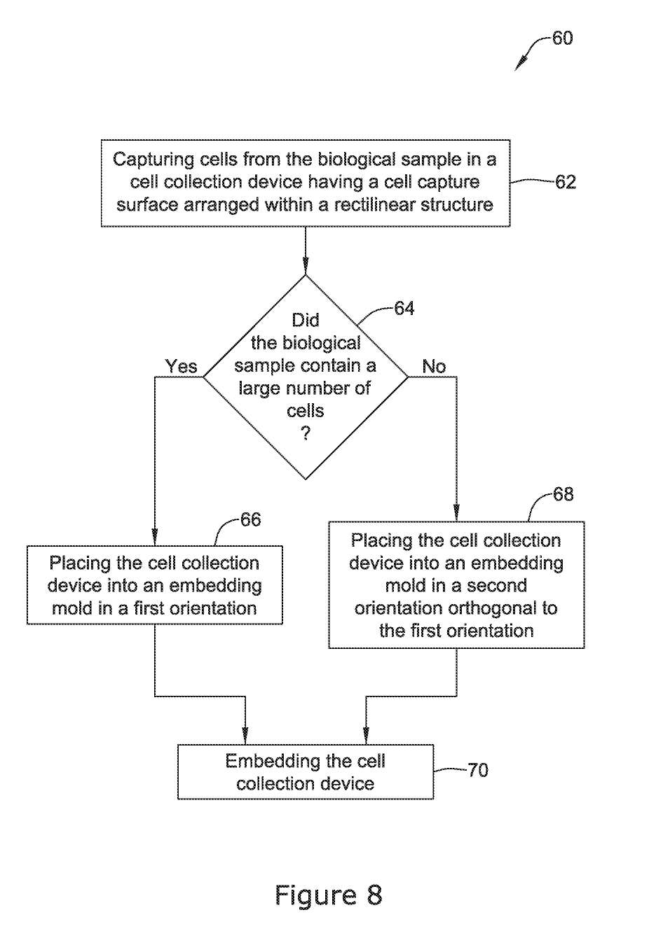

FIG. 8 is a flow diagram showing a method 60 of processing cells from a biological sample. As generally indicated at block 62, cells may be captured from the biological sample in a cell collection device (such as the cell collection device 20) having a cell capture surface (such as the cell capture surface 30) arranged within a rectilinear structure (such as the rectilinear structure 24). The cell collection device may be placed into an embedding mold in an orientation based upon whether or not the biological sample contained a large number of cells. This determination may be made as shown at decision block 64. If the biological sample contained a large number of cells, control passes to block 66 and the cell collection device may be placed an embedding mold in a first orientation (such as the Orientation A). Conversely, if the biological sample did not contain a large number of cells, control passes to block 68 and the cell collection device may be placed in the embedding mold in a second orientation (such as the Orientation B). In either event, the cell collection device is then embedded, as generally indicated at block 70. In some cases, the decision block 64 may instead be based on whether there is a desire to have more cells per slide, and perhaps fewer slides, or more slides per sample.

It should be understood that this disclosure is, in many respects, only illustrative. Changes may be made in details, particularly in matters of shape, size, and arrangement of steps without exceeding the scope of the disclosure. This may include, to the extent that it is appropriate, the use of any of the features of one example embodiment being used in other embodiments. The invention's scope is, of course, defined in the language in which the appended claims are expressed.

What is claimed is:

1. A cell filtration assembly, comprising:
a centrifugation tube comprising a tapered end;
a cell collection device adapted to be secured within the centrifugation tube proximate the tapered end thereof, the cell collection device comprising a rectilinear structure configured to permit fluid to flow through the rectilinear structure; and
a funnel structure to direct fluid into the cell collection device.

2. The cell filtration assembly of claim 1, wherein the cell collection device further comprises at least one filter membrane secured relative to the rectilinear structure, the at least one filter membrane permitting fluid to flow through the rectilinear structure.

3. The cell filtration assembly of claim 1, further comprising a cell capture surface secured relative to the rectilinear structure, the cell capture surface comprising a filter membrane.

4. The cell filtration assembly of claim 1, further comprising a cell capture surface secured relative to the rectilinear structure, the cell capture surface comprising a fluid-impervious surface.

5. The cell filtration assembly of claim 1, wherein the cell collection device comprises a material that can be embedded and sectioned.

6. The cell filtration assembly of claim 1, wherein the cell collection device is adapted to be placed in a mold for embedding and sectioning in a horizontal orientation.

7. The cell filtration assembly of claim 1, wherein the cell collection device is adapted to be placed in a mold for embedding and sectioning in a vertical orientation.

8. The cell filtration assembly of claim 1, wherein the funnel structure is adapted to be secured within the centrifugation tube via a frictional fit.

9. The cell filtration assembly of claim 1, wherein the funnel structure is adapted to secure the cell collection device in position within the tapered end of the centrifugation tube.

10. A cell collection device, comprising:
a rectilinear structure configured to permit fluid to flow through the rectilinear structure;
a filter membrane secured relative to a side panel of the rectilinear structure; and
a cell capture surface secured relative to a bottom panel of the rectilinear structure;
wherein the rectilinear structure is dimensioned to enable the cell collection device to be placed in a mold and subsequently embedded in either a vertical orientation or a horizontal orientation.

11. The cell collection device of claim 10, wherein the rectilinear structure has a first dimension of about 5 millimeters or less.

12. The cell collection device of claim 11, wherein the first dimension is about 5 millimeters.

13. The cell collection device of claim 10, wherein the rectilinear structure has a second dimension, orthogonal to the first dimension, that is about 5 millimeters or less.

14. The cell collection device of claim 13, wherein the second dimension is about 3 millimeters.

15. The cell collection device of claim 10, wherein the cell capture surface comprises a filter membrane.

16. The cell collection device of claim 15, wherein the cell capture surface comprises a filter membrane having a pore size of about 5 micrometers.

17. The cell collection device of claim 10, wherein the cell capture surface comprises a fluid-impervious surface.

18. The cell collection device of claim 10, wherein the cell collection device is formed of a polymer.

19. A method of processing cells from a biological sample, the method comprising:
capturing cells from the biological sample in a cell collection device having a cell capture surface arranged within a rectilinear structure;
placing the cell collection device into an embedding mold in a first orientation if the biological sample contained a large number of cells;
placing the cell collection device into the embedding mold in a second orientation orthogonal to the first orientation if the biological sample did not contain a large number of cells; and
embedding the cell collection device in wax.

20. The method of claim 19, further comprising subsequently sectioning the biological sample.
